(19) United States
(12) Patent Application Publication
(10) Pub. No.: US 2023/0300295 A1
(43) Pub. Date: Sep. 21, 2023

(54) IMMERSIVE SHARE FROM MEETING ROOM

(71) Applicant: Cisco Technology, Inc., San Jose, CA (US)

(72) Inventors: Kristian Tangeland, Oslo (NO); Julie Sildnes, Oslo (NO)

(21) Appl. No.: 17/699,407

(22) Filed: Mar. 21, 2022

(51) Int. Cl. H04N 7/15; G06V 40/10; H04L 12/18

(52) U.S. Cl. CPC H04N 7/157; H04N 7/152; G06V 40/103; H04L 12/1822; H04L 12/1831

(57) ABSTRACT

A conference endpoint receives a selection of an option to initiate a sharing session in which a video of a user is overlaid on a presentation of shared content during a video communication session, the user being one of multiple users participating in the video communication session via the conference endpoint. The conference endpoint identifies one of the multiple users as a presenter for the shared content; and transmits, to a meeting server, information associated with the sharing session, which includes one of a video of the presenter overlaid on the shared content, or the shared content, a video of the multiple users, and information identifying the presenter in the video of the multiple users to a meeting server for overlaying, by the meeting server or a receiver conference endpoint, video of the presenter on the shared content during the video communication session.

### TECHNICAL FIELD

The present disclosure relates to online video meetings/conferences.

### BACKGROUND

When presenting shared content during an online meeting, video of a presenter may be separated from the surroundings and displayed in front of the shared content. Displaying the presenter in front of the shared content results in more engaging presentations in which the presenter may use body language to point out details and an audience may focus their attention on one area of the screen.

### BRIEF DESCRIPTION OF THE DRAWINGS

FIG. 1 is a block diagram of an online video conference/meeting system configured to support overlaying video of a participant over a shared content during a video conference/meeting, according to an example embodiment.

FIGS. 2A and 2B show examples of manually selecting a participant as a presenter of shared content, according to an example embodiment.

FIGS. 3A and 3B show examples of automatically selecting a participant as a presenter based on voice detection, according to an example embodiment.

FIGS. 4A and 4B show examples of selecting multiple participants as presenters, according to an example embodiment.

FIG. 5 is a flow diagram illustrating a method of identifying a participant as a presenter of shared content for overlaying video of the presenter on the shared content, according to an example embodiment.

FIG. 6 is a hardware block diagram of a device that may be configured to perform the conference endpoint based operations involved in identifying a participant as a presenter of shared content for overlaying video of the presenter on the shared content, according to an example embodiment.

FIG. 7 is a hardware diagram of a computer device that may be configured to perform the meeting server operations involved in identifying a participant as a presenter of shared content for overlaying video of the presenter on the shared content, according to an example embodiment.

### DESCRIPTION OF EXAMPLE EMBODIMENTS

### Overview

In one embodiment, a method is provided for controlling handling of video streams in a video communication session, such as a video conference. The method includes receiving a selection of an option to initiate a sharing session in which a video of a user is overlaid on a presentation of shared content during a video communication session, the user being one of multiple users participating in the video communication session via a conference endpoint; identifying one of the multiple users as a presenter for the shared content; and transmitting information associated with the sharing session, the information associated with the sharing session including one of: a video of the presenter overlaid on the shared content, or the shared content, a video of the multiple users, and information identifying the presenter in the video of the multiple users for overlaying, by the meeting server or a receiver conference endpoint, video of the presenter on the shared content during the video communication session.

### Example Embodiments

Some videoconference endpoint devices may be used for performing immersive sharing during online meetings or communication sessions. Immersive sharing involves separating a video of a user from the user's background and placing the video of the user on top of a presentation or other shared content to allow the user to interact with the presentation/shared content during the online meeting. By using immersive sharing, an audience may focus attention on one point of the screen without having to separately view the presentation/shared content and the user.

A videoconference endpoint may be able to separate the foreground (e.g., people) from the background (e.g., items in a room) using a (machine learning-based) segmentation model to detect both individuals and multiple people in a scene. When the user is participating in an online meeting using a personal endpoint device, the endpoint device may be able to identify the user as a presenter of shared content and transmit the shared content and the video of the user to a meeting server for sharing with other users in the online meeting. However, if the user is participating in the online meeting in an area with other users (e.g., in a conference or meeting room with multiple participants), it may be difficult to identify which user is presenting the shared content for the purpose of extracting the video of the user from the background.

Embodiments described herein provide for identifying which participant is presenting shared content when multiple participants are participating in an online meeting via a videoconference endpoint. Embodiments described herein further provide for transmitting the shared content, video of the participants, and an indication of which participant in the video is presenting the shared content to a meeting server for presenting the video of the identified participant on top of the shared content.

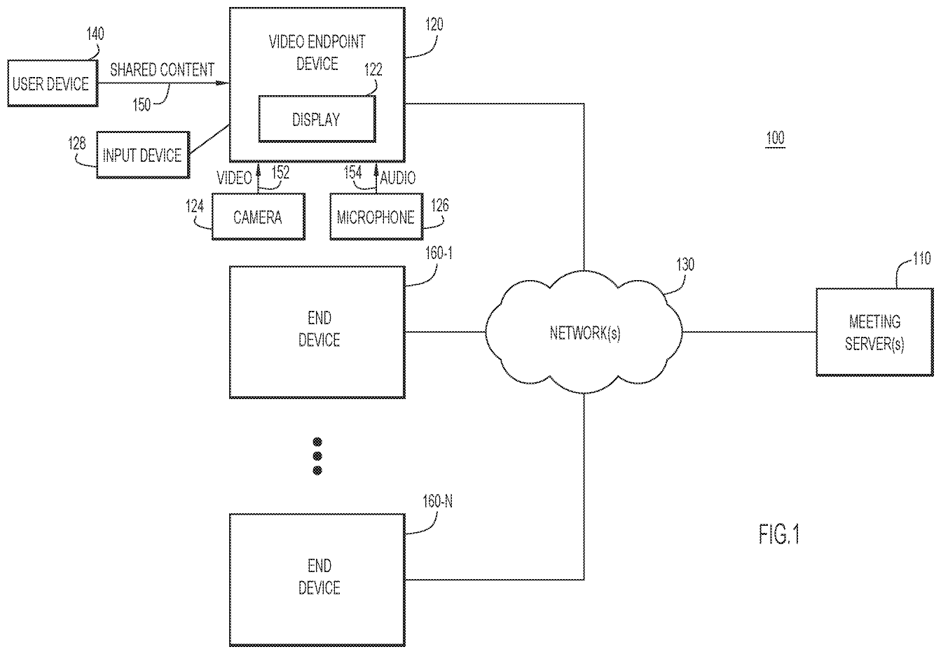

Reference is first made to FIG. 1. FIG. 1 shows a block diagram of a system 100 that is configured to provide online meeting services that include services for presenting video of one or more users on top of shared content during an online meeting. The system 100 includes one or more meeting server(s) 110, a video endpoint device 120 and a plurality of end devices 160-1 to 160-N that communicate with meeting server(s) 110 via one or more networks 130, and a user device 140 that communicates with video endpoint device 120 via a wired or wireless connection. The meeting server(s) 110 are configured to provide an online meeting service for hosting a communication session among video endpoint device 120 and end devices 160-1 to 160-N.

The video endpoint device 120 may be a videoconference endpoint designed for personal use (e.g., a desk device used by a single user) or for use by multiple users (e.g., a videoconference endpoint in a meeting room). In some embodiments, video endpoint device 120 may be configured to open content to display or share (e.g., when a digital whiteboard is accessed directly on video endpoint device 120).

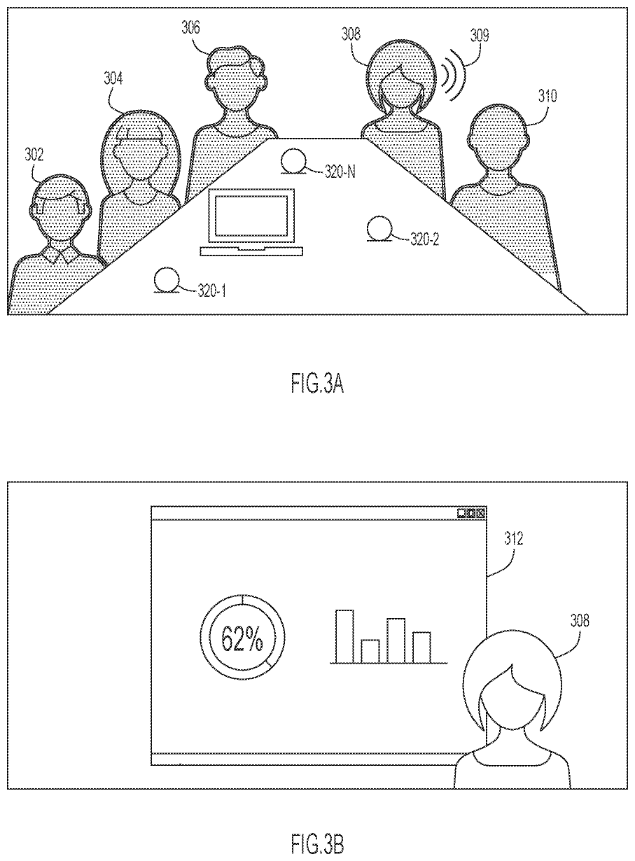

Video endpoint device 120 may include display 122, camera 124, and microphone 126. In one embodiment, display 122, camera 124, and/or microphone 126 may be integrated with video endpoint device 120. In another embodiment, display 122, camera 124, and/or microphone 126 may be separate devices connected to video endpoint device 120 via a wired or wireless connection. Display 122 may include a touch screen display configured to receive an input from a user. Video endpoint device 120 may further include an input device 128, such as a keyboard or a mouse, that may be integrated in or connected to video endpoint device 120. Although only one display 122, one camera 124, one microphone 126, and one input device 128 are illustrated in FIG. 1, multiple displays 122, cameras 124, microphones 126 and/or input devices 128 may be integrated in or connected to video endpoint device 120. For example, a microphone array may be included instead of a single microphone 126, and uses of the microphone array are described below in connection with FIGS. 3A and 3B. Likewise, multiple cameras (instead of a single camera 124) may be provided to simultaneously capture multiple views of a meeting room, uses of which are described below.

User device 140 may be a tablet, laptop computer, desktop computer, Smartphone, virtual desktop client, virtual whiteboard, or any user device now known or hereinafter developed that can connect to video endpoint device 120 (e.g., for sharing content). User device 140 may have a dedicated physical keyboard or touch-screen capabilities to provide a virtual on-screen keyboard to enter text. User device 140 may also have short-range wireless system connectivity (such as Bluetooth™ wireless system capability, ultrasound communication capability, etc.) to enable local wireless connectivity with video endpoint device 120 in a meeting room or with other user devices in the same meeting room. User device 140 may store content (e.g., a presentation, a document, images, etc.) and user device 140 may connect to video endpoint device 120 for sharing the content with other user devices via video endpoint device 120 during an online meeting or communication session.

End devices 160-1 to 160-N may be video endpoint devices similar to video endpoint device 120 or user devices with meeting applications for facilitating communication with meeting server(s) during the online meeting. When one or more of the end devices 160-1 to 160-N is implemented as a video endpoint device, the one or more of the end devices 160-1 to 160-N may be connected to a user device similar to user device 140. Users of end devices 160-1 to 160-N may participate in an online meeting or communication session with the users of video endpoint device 120.

The meeting server 110 and the video endpoint device 120 are configured to support immersive sharing in which videos of one or more users are placed on top of shared content during online meetings. In the example illustrated in FIG. 1, video endpoint device 120 may be in a meeting or conference room that includes multiple users participating in an online meeting via the video endpoint device 120. In the example described in FIG. 1, video endpoint device 120 may receive a selection of an option to begin an immersive sharing session. For example, video endpoint device 120 may receive an input from a user via display 122 (e.g., when display 122 is a touch screen) or via input device 128 indicating that the users would like to start an immersive sharing session. In one embodiment, at 150, video endpoint device 120 may receive shared content from user device 140. The shared content may include a presentation, a document, one or more images, or other content to be shared with end devices 160-1 to 160-N during the online meeting. In another embodiment, video endpoint device 120 may directly open content to share during the online meeting instead of receiving the content from user device 140.

At 152, video endpoint device 120 may receive video from camera 124 and at 154, video endpoint device 120 may receive audio data from microphone 126. The video and audio data may include video and audio of one or more users participating in the online meeting via video endpoint device 120. For example, the video and audio data may include video of the users in the meeting/conference room and audio of the user or users presenting or describing the shared content.

Video endpoint device 120 may detect the participants in the video of the meeting/conference room and identify which participant or participants is/are presenting the shared content. To detect the participants in the room, video endpoint device 120 may apply a machine learning-based segmentation model to separate the foreground (people) from the background (room). In some embodiments, the detection of people may be augmented with additional sensors (e.g., radar or other depth sensors such as time-of-flight, structured light, etc.). Silhouettes or masks indicating locations of the different participants in the meeting room may be added to the video of the meeting/conference room. Each silhouette/mask defines an area in the video that contains a participant in the meeting room.

As further described below, in one embodiment, when a user has been identified as a presenter, video endpoint device 120 may overlay video of the presenter defined by the silhouette/mask on the shared content and transmit the video of the presenter overlaid on the shared content to meeting server(s) 110. In another embodiment, video endpoint device 120 may transmit information associated with the silhouette/mask surrounding the presenter to the meeting server(s) 110 as metadata with the video stream of the meeting/conference room and the shared content so that the meeting server(s) 110 or receiver devices (e.g., end devices 160-1 to 160-N) may identify the presenter from the video stream, extract video of the presenter, and place the video of the presenter on top of the shared content.

When the participants in the video stream have been detected, one or more participants may be identified as presenters of the shared content. The one or more participants may be identified as the presenters in a number of different ways. In one embodiment, a presenter of the shared content may be selected based on role. For example, a host or co-host of the meeting may designate (through a user interface) a participant of the meeting as a presenter of the shared content. When the participant in the online meeting is assigned a role as the presenter, facial recognition may be used to identify the presenter and the silhouette/mask corresponding to the presenter may be selected so that video of the presenter may be extracted and placed on top of the shared content. In one embodiment, video endpoint device 120 may identify the participant as the presenter using facial recognition and video endpoint device 120 may transmit video of the presenter overlaid on the shared content or an indication of the silhouette/mask corresponding to the presenter to meeting server(s) with the video stream and the shared content. In another embodiment, meeting server(s) 110 may receive the video stream with the silhouettes/masks from video endpoint device 120 and meeting server(s) 110 may select the silhouette/mask corresponding to the presenter using facial recognition.

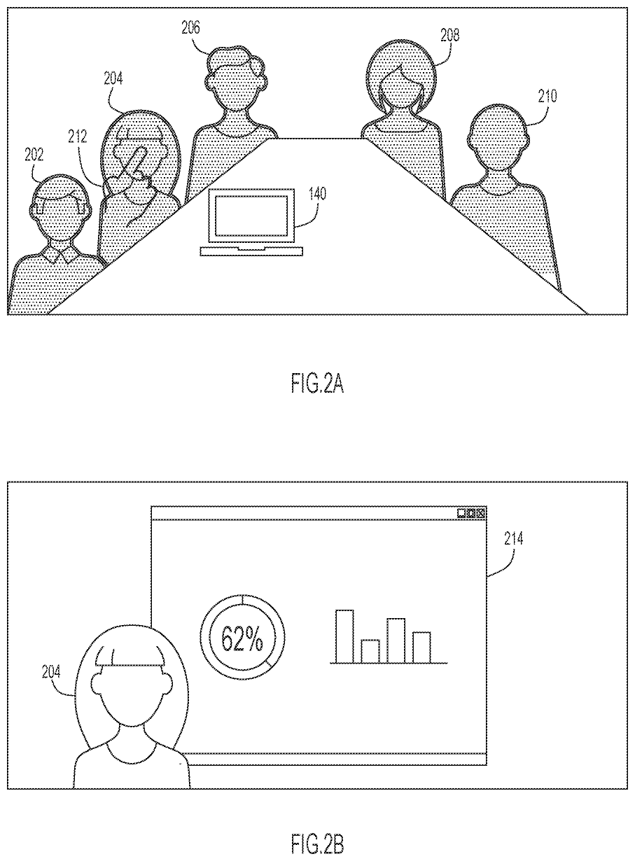

In other embodiments described below with respect to FIGS. 2A and 2B, video endpoint device 120 may display a picture or video of the participants in the meeting/conference room. The picture or video includes the silhouettes/masks of the participants and one of the participants may manually select the participant(s) who is/are the presenter. In another embodiment described below with respect to FIGS. 3A and 3B, an active speaker may be determined using audio position information from a speaker tracking microphone array or using microphones with known locations and the position information may be matched with a detected silhouette/mask of a participant to identify the participant who is presenting the shared content. Additional or different ways of determining which user is presenting the shared content are envisioned. For example, it may be desirable for a user, at an end device that is connected to the meeting, to be able to designate the presenter(s).

When the presenter has been identified from the group of participants, video endpoint device 120 may transmit information to meeting server(s) 110 via a content channel for the immersive sharing session. In one embodiment, video endpoint device 120 may place the video of the presenter(s) on top of (overlaying) the shared content and transmit the shared content with the video of the presenter(s) overlaying the shared content to the meeting server(s) 110. In another embodiment, video endpoint device 120 may transmit the shared content, the video stream of the participants, and metadata identifying the silhouette(s)/mask(s) of the presenter(s) to meeting server(s) 110. Meeting server(s) 110 or end devices 160-1 to 160-N may extract the video of the presenter(s) identified by the metadata and place the video of the presenter(s) on top of (overlaying) the shared content and for displaying to participants in the online meeting.

In some embodiments, multiple cameras may be used to capture video of the meeting room. In these embodiments, an indication of the camera to use during the immersive sharing session may be received from a user. In one example, when video endpoint device 120 receives a selection to begin the immersive sharing session, video endpoint device 120 may present options of different cameras that may be used to capture video for the immersive sharing session. A user may determine the best camera and may make a manual selection of the camera to use. In another example, the system may automatically determine which camera to use or may switch between cameras in different situations. For better eye contact, a camera close to where the presentation is displayed locally (e.g., on user device 140) may be used.

Reference is now made to FIGS. 2A and 2B, with continued reference to FIG. 1. FIGS. 2A and 2B show an example in which a presenter is manually selected using a self-view. In the example illustrated in FIG. 2A, video endpoint device 120 is located in a conference room with five participants—participant 202, participant 204, participant 206, participant 208, and participant 210. In addition, video endpoint device 120 has received an option to begin an immersive sharing session in which a video of one of participants 202-210 is to be placed on top of shared content (e.g., shared content 214 in FIG. 2B). In one embodiment, video endpoint device 120 may have additionally presented options of ways to identify the presenter for the immersive sharing session and may have received a selection of an option to identify presenter manually using self-view.

To identify a participant in the room as a presenter of the shared content, video endpoint device 120 may utilize position and shape information from a foreground/background segmentation tool to create a user interface to present to the participants. FIG. 2A illustrates a user interface presented to the participants that includes a self-view (e.g., an image or a video) of the conference room with an overlay of detected silhouettes of participants 202-210. A user may manually select which participant shown in the user interface is the presenter. In one embodiment, video endpoint device 120 may display the self-view of the conference room on display 122 and, when display 122 is a touch screen, a participant may select one of participants 202-210 as the presenter by touching an image of the presenter on the touch screen. In another embodiment, video endpoint device 120 may display a selection tool 212 (e.g., a cursor, an arrow, a finger, etc.) to allow a user to move about within the displayed view to select which one of the participants 202-210 is the presenter using, for example, a mouse or other input device, such as input device 128 (not illustrated in FIG. 2A). In the example illustrated in FIG. 2A, participant 204 has been selected as the presenter.

Video endpoint device 120 may receive the selection of participant 204 and may additionally obtain shared content 214 (e.g., video endpoint device 120 may directly open shared content 214 or may receive shared content 214 from user device 140). Video endpoint device 120 may transmit the shared content, a video stream of participants 202-210, and metadata identifying the silhouette of participant 204 to meeting server(s) 110 over a content channel.

FIG. 2B illustrates an example in which video of participant 204 is placed on top of shared content 214. In one embodiment, video endpoint device 120 may place the video of participant 204 on top of (overlaying) the shared content and transmit the video of participant 204 overlaying the shared content to the meeting server(s) 110. In another embodiment, video endpoint device 120 may transmit the shared content, the video stream of participants 202-210, and the metadata identifying the silhouette of participant 204 to meeting server(s) 110. Meeting server(s) 110 may place the video of participant 204 on top of (overlaying) the shared content 214 and may transmit the video of participant 204 on top of the shared content 214 to end devices 160-1 to 160-N for display. Alternatively, meeting server(s) 110 may transmit the shared content, the video stream of participants 202-210, and the metadata identifying the silhouette of participant 204 to end devices 160-1 to 160-N and end devices 160-1 to 160-N may place the video of participant 204 on top of shared content 214 for display on end devices 160-1 to 160-N.

Reference now is made to FIGS. 3A and 3B. FIGS. 3A and 3B show an example in which a presenter of shared content is automatically selected based on activity. In the example illustrated in FIGS. 3A and 3B, a selection of the silhouette of the presenter is automated by detecting an active speaker in a meeting room. In one embodiment, video endpoint device 120 may have received a selection indicating that the presenter of the shared content (e.g., shared content 312 of FIG. 3B) is to be selected automatically based on detecting an active speaker.

As shown in FIG. 3A, an immersive sharing session may have been initiated in a meeting room which includes user device 140, microphones 320-1, 320-2 to 320-N and five participants—participant 302, participant 304, participant, 306, participant 308, and participant 310. Microphones 320-1 to 320-N may be part of a speaker tracking microphone array or may be microphones that are individually placed at known locations on a table or in different locations in the meeting room. Microphones 320-1 to 320-N may detect audio from participants 302-310 and a position of a speaker may be determined using the speaker tracking microphone array or based on the known locations of the microphones 320-1 to 320-N.

Video endpoint device 120 may use a segmentation model to determine a silhouette for each participant 302-310 in the conference room. The position of the speaker (the speaking participant) may be matched with a corresponding silhouette. In the example illustrated in FIG. 3A, the location of the speaker has been matched with the silhouette corresponding to participant 308, as shown by the icon 309 displayed next to participant 308. Video endpoint device 120 may transmit shared content 312 (e.g., shared content opened at video endpoint device 120 or received from user device 140), a video stream of participants 302-310, and metadata identifying the silhouette of participant 308 to meeting server(s) 110 over a content channel.

FIG. 3B illustrates an example in which video of participant 308 has been placed on top of shared content 312. In one embodiment, video endpoint device 120 may place the video of participant 308 on top of (overlaying) the shared content and transmit the shared content with the video of participant 308 overlaying the shared content to the meeting server(s) 110. In another embodiment, video endpoint device 120 may transmit the shared content, the video of participants 302-310, and the metadata identifying the silhouette of participant 308 to meeting server(s) 110. Meeting server(s) 110 may place the video of participant 308 on top of the shared content 312 and may transmit the video of participant 308 on top of the shared content 312 to end devices 160-1 to 160-N for display. Alternatively, meeting server(s) 110 may transmit the shared content, the video of participants 302-310, and the metadata identifying the silhouette of participant 308 to end devices 160-1 to 160-N and end devices 160-1 to 160-N may place the video of participant 308 on top of shared content 312 for display on end devices 160-1 to 160-N.

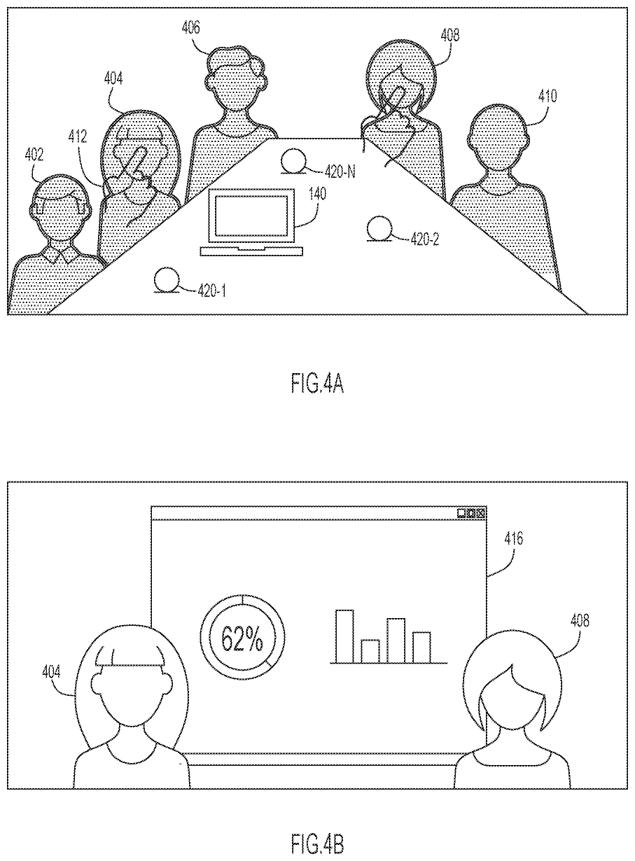

Reference now is made to FIGS. 4A and 4B. FIGS. 4A and 4B show an example in which multiple presenters are selected for simultaneously being presented on top of shared content. In the example illustrated in FIGS. 4A and 4B, an immersive sharing session has been initiated in a conference room with user device 140, microphones 420-1 to 420-N, and five participants—participant 402, participant 404, participant 406, participant 408, and participant 410. Video endpoint device 120 may determine silhouettes for the participants 402-410 in the conference room using a segmentation model, as described above.

If a selection of an option for performing manual selection of presenters has been received at video endpoint device 120, video endpoint device 120 may present a self-view of the conference room with an overlay of detected silhouettes of participants 402-410. A user may select multiple participants as presenters. In one embodiment, video endpoint device 120 may display the self-view of the conference room on display 122 and a user may select multiple ones of participants 202-210 as presenters by touching images of the presenters on display 122. In another embodiment, video endpoint device 120 may display a selection tool 412 (e.g., a cursor, an arrow, a finger, etc.) to allow a user to select several participants 402-410 as presenters. The user may select the participants using, for example, a mouse or other input device 128 (not shown in FIG. 4A). In the example illustrated in FIG. 4A, participants 404 and 408 have been selected as presenters.

If a selection of an option for automatically selecting the presenters based on detecting an active speaker has been received, video endpoint device 120 may determine active speakers using microphones 420-1, 420-2 to 420-N and match locations of the active speakers to silhouettes of participants 402-410 in a similar manner as described above with respect to FIGS. 3A and 3B. When multiple speakers have been identified, the most recent active speakers (e.g., the most recent two speakers) may be matched to the silhouettes of the participants (e.g., participants 404 and 408).

In the case in which the presenter is automatically selected based on a role, multiple users may be assigned a presenter role. In this example, facial recognition may be used to identify the presenters and the corresponding silhouettes in a similar manner as described above.

When the presenters (e.g., participants 404 and 408) have been identified, in one embodiment, video endpoint device 120 may transmit videos of participants 404 and 408 overlaid on the shared content (e.g., shared content 416 of FIG. 4B) to meeting server(s) 110. In another embodiment, video endpoint device 120 may transmit the shared content, a video stream of participants 402-410, and metadata identifying the silhouettes of participants 404 and 408 to meeting server(s) 110.

In some embodiments, multiple users in different locations may be designated as presenters. For example, a host of the online meeting (or another participant) may designate a first participant who is participating in the online meeting via video endpoint device 120 as a presenter and may additionally designate a second participant who is participating in the online meeting via end device 160-1 as a presenter. In these embodiments, video endpoint device 120 transmits video and metadata including information identifying the silhouette of the first participant to meeting server(s) 110 and end device 160-1 (or a meeting application associated with end device 160-1) transmits video and metadata including information identifying the silhouette of the second participant to meeting server(s) 110. Additionally, video endpoint device 120 or end device 160-1 transmits shared content to meeting server(s) 110 (e.g., based on where the shared content is stored). When the shared content is shared during the online meeting, meeting server(s) 110 or receiver endpoints (e.g., end device 160-N) use the metadata identifying the silhouettes of the first and second participants to extract the videos of the first and second participants/presenters and place the videos on top of the shared content so the videos of the first and second participants/presenters are displayed on top of the shared content at the same time.

FIG. 4B illustrates an example in which videos of participants 404 and 408 are displayed on top of shared content 416. Locations of the videos of participants 404 and 408 on top of shared content 416 may be controlled manually or automatically. For example, placement of the videos of participants 404 and 408 on top of shared content 416 may be determined by a user (e.g., a host of the meeting). In another example, placement of the videos of participants 404 and 408 on top of the shared content 416 may be made based on where the participants 404 and 406 are physically located. In another example, placement of the videos of participants 404 and 408 may dynamically change (e.g., based on a user selection, which participant is talking, where the participants are looking, if the physical locations of the participants change, etc.).

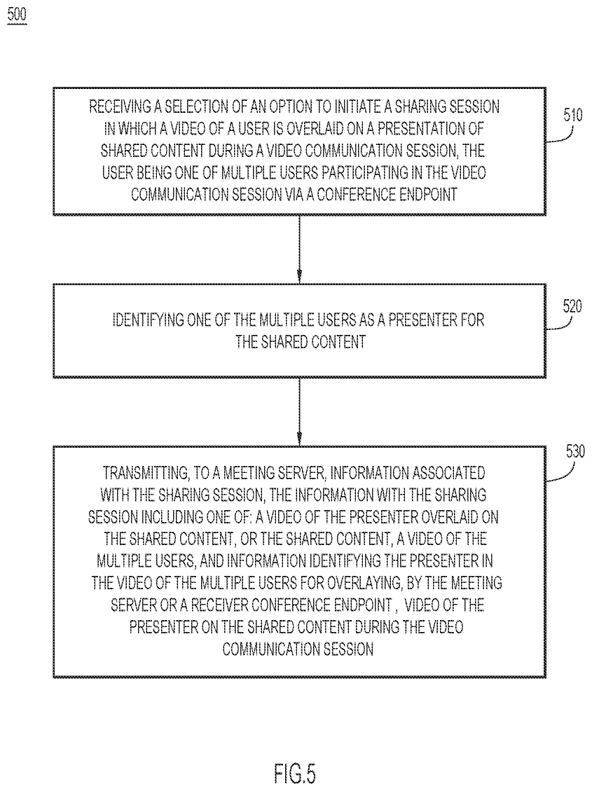

Reference is now made to FIG. 5. FIG. 5 is a flow diagram illustrating a method 500 of identifying a presenter of shared content during an online meeting for displaying video of the presenter on top of the shared content, according to an embodiment. Method 500 may be performed by video endpoint device 120 in conjunction with user device 140, meeting server(s) 110, and/or end devices 160-1 to 160-N.

At 510, a selection of an option to initiate a sharing session in which a video of a user is overlaid on a presentation of shared content during a video communication session is received. The user is one of multiple users participating in the video communication session via a conference endpoint. For example, multiple participants may participate in an online meeting or video communication session in a conference or meeting room via video endpoint device 120. Video endpoint device 120 may receive a selection of an option to perform an immersive sharing session in which video of one of the participants in the meeting/conference room is placed on top of shared content and shared with other participants in the video communication session.

At 520, one of the multiple users is identified as a presenter for the shared content. For example, video endpoint device 120 may use a segmentation model to separate the participants from the background in a video stream of the participants in the conference room. The video endpoint device 120 may additionally generate silhouettes that define areas in the video stream that contain the participants. In one embodiment, video endpoint device 120 may identify the presenter by receiving a selection of the presenter, as described above with respect to FIGS. 2A and 2B. In another embodiment, video endpoint device 120 may automatically identify the presenter based on detecting an active speaker, as described above with respect to FIGS. 3A and 3B. In another embodiment, video endpoint device 120 may automatically identify the presenter using facial recognition to identify a participant who had been assigned a presenter role. In other embodiments, the presenter may be identified in different ways. Video endpoint device 120 may identify a silhouette that corresponds to the identified presenter.

At 530, information associated with the sharing session is transmitted to a meeting server. In one embodiment, the information associated with the sharing session may include a video of the presenter overlaid on the shared content. In another embodiment, the information associated with the sharing session may include the shared content, a video of the multiple users, and information identifying the presenter in the video of the multiple users for overlaying, by the meeting server or a receiver conference endpoint, video of the presenter on the shared content during the video communication session.

For example, video endpoint device 120 may overlay a video of the presenter on top of the shared content (e.g., shared content opened by video endpoint device 120 or received from a user device, such as user device 140) and transmit the video of the presenter overlaid on shared content to meeting server(s) 110. As another example, video endpoint device 120 may transmit the shared content, a video stream of the multiple users, and an indication of a silhouette associated with the presenter to meeting server(s) 110 over a content channel. In some embodiments, meeting server(s) 110 may overlay the video of the presenter identified by the silhouette on the shared content for display on devices of users participating in the online meeting. In other embodiments, meeting server(s) 110 may transmit the shared content, the video of the multiple users, and the indication of the silhouette to the devices (receiver conference endpoints) of the users participating in the online meetings (e.g., end devices 160-1 to 160-N) and the devices may display the video of the presenter identified by the silhouette on top of the shared content.

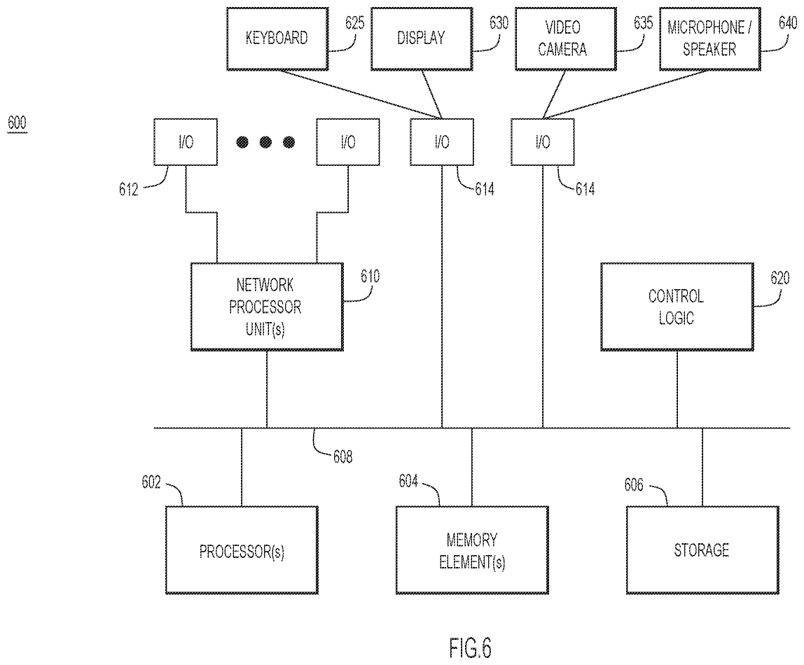

Referring to FIG. 6, FIG. 6 illustrates a hardware block diagram of a computing/computer device 600 that may perform functions of a video endpoint device or an end device associated with operations discussed herein in connection with the techniques depicted in FIGS. 1-5. In various embodiments, a computing device, such as computing device 600 or any combination of computing devices 600, may be configured as any devices as discussed for the techniques depicted in connection with FIGS. 1-5 in order to perform operations of the various techniques discussed herein.

In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. Examples of wireless communication capabilities include short-range wireless communication (e.g., Bluetooth), wide area wireless communication (e.g., 4G, 5G, etc.). In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computer device 600. For example, I/O interface(s) 614 may provide a connection to external devices such as a keyboard 625, keypad, a touch screen, and/or any other suitable input and/or output device now known or hereafter developed. This may be the case, in particular, when the computer device 600 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, such as display 630 shown in FIG. 6, particularly when the computer device 600 serves as a user device as described herein. Display 630 may have touch-screen display capabilities. Additional external devices may include a video camera 635 and microphone/speaker combination 640. While FIG. 6 shows the display 630, video camera 635 and microphone/speaker combination 640 as being coupled via one of the I/O interfaces 614, it is to be understood that these components may instead be coupled to the bus 608.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

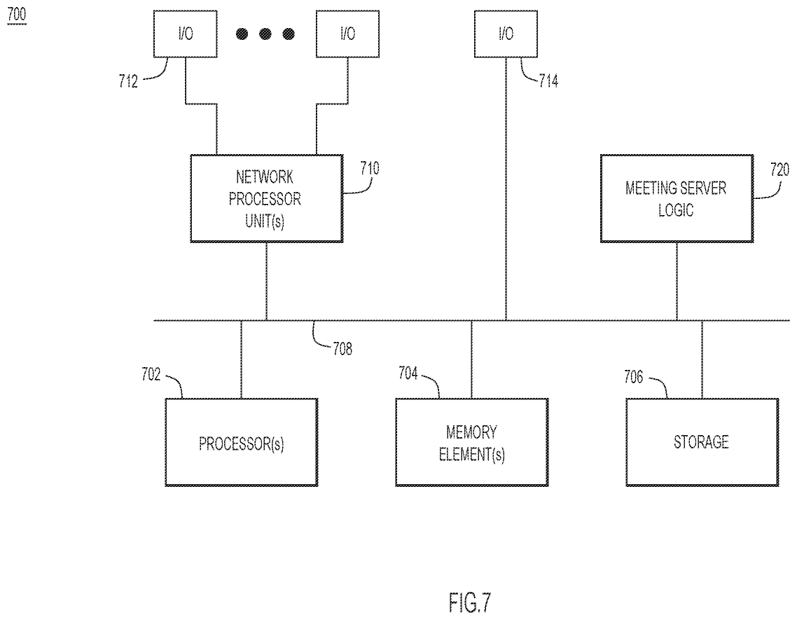

FIG. 7 illustrates a block diagram of a computing device 700 that may perform the functions of the meeting server(s) 110 described herein. The computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and meeting server logic 720. In various embodiments, instructions associated with the meeting server logic 720 is configured to perform the meeting server operations described herein, including those depicted by the flow chart for method 500 shown in FIG. 5.

In one form, a computer-implemented method is provided comprising: receiving a selection of an option to initiate a sharing session in which a video of a user is overlaid on a presentation of shared content during a video communication session, the user being one of multiple users participating in the video communication session via a conference endpoint; identifying one of the multiple users as a presenter for the shared content; and transmitting, to a meeting server, information associated with the sharing session, the information associated with the sharing session including one of: a video of the presenter overlaid on the shared content, or the shared content, a video of the multiple users, and information identifying the presenter in the video of the multiple users for overlaying, by the meeting server or a receiver conference endpoint, video of the presenter on the shared content during the video communication session.

In one example, the computer-implemented method further comprises detecting each user of the multiple users in the video of the multiple users; and generating, for each user, a silhouette that defines an area in the video of the multiple users that contains the user; wherein identifying the one of the multiple users as the presenter includes identifying a first silhouette that defines an area in the video of the multiple users that contains the presenter; and wherein the information identifying the presenter includes information associated with the first silhouette. In another example, identifying the one of the multiple users as the presenter comprises: presenting an image of the multiple users; and receiving a selection of the presenter from the image.

In another example, identifying the one of the multiple users comprises: receiving audio data from one or more microphones; identifying an active speaker based on the audio data; and matching the active speaker to the one of the multiple users. In another example, the computer-implemented method further comprises identifying a second user of the multiple users as a second presenter; and the information associated with the sharing session further comprises one of: videos of the presenter and the second presenter overlaid on the shared content, or the shared content, the video of the multiple users, and information identifying the presenter and the second presenter in the video of the multiple users.

In another example, transmitting the information associated with the sharing session further comprises transmitting the shared content, the video of the multiple users, and information identifying the presenter in the video of the multiple users to the meeting server for overlaying, by the meeting server or the receiver conference endpoint, the video of the presenter and video of a second presenter participating in the video communication session via a second conference endpoint on the shared content during the video communication session. In another example, transmitting the information associated with the sharing session comprises transmitting the information associated with the sharing session using a content channel.

In another form, an apparatus is provided comprising: a memory; a network interface configured to enable network communication; and a processor, wherein the processor is configured to perform operations comprising: receiving a selection of an option to initiate a sharing session in which a video of a user is overlaid on a presentation of shared content during a video communication session, the user being one of multiple users participating in the video communication session via a conference endpoint; identifying one of the multiple users as a presenter for the shared content; and transmitting, to a meeting server, information associated with the sharing session, the information associated with the sharing session including one of: a video of the presenter overlaid on the shared content, or the shared content, a video of the multiple users, and information identifying the presenter in the video of the multiple users for overlaying, by the meeting server or a receiver conference endpoint, video of the presenter on the shared content during the video communication session.

In yet another form, one or more non-transitory computer readable storage media encoded with instructions are provided that, when executed by a processor of a conference endpoint, cause the processor to execute a method comprising: receiving a selection of an option to initiate a sharing session in which a video of a user is overlaid on a presentation of shared content during a video communication session, the user being one of multiple users participating in the video communication session via the conference endpoint; identifying one of the multiple users as a presenter for the shared content; and transmitting, to a meeting server, information associated with the sharing session, wherein the information associated with the sharing session comprises one of: a video of the presenter overlaid on the shared content, or the shared content, a video of the multiple users, and information identifying the presenter in the video of the multiple users for overlaying, by the meeting server or a receiver conference endpoint, video of the presenter on the shared content during the video communication session

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A computer-implemented method comprising:
receiving a selection of an option to initiate a sharing session in which a video of a user is overlaid on a presentation of shared content during a video communication session, the user being one of multiple users participating in the video communication session via a conference endpoint, the multiple users and the conference endpoint being located in a same location;
identifying one of the multiple users located in the same location as a presenter for the shared content; and
transmitting, to a meeting server, information associated with the sharing session, the information associated with the sharing session including one of:
a video of the presenter overlaid on the shared content, or
the shared content, a video of the multiple users, and information identifying the presenter in the video of the multiple users for overlaying, by the meeting server or a receiver conference endpoint, video of the presenter on the shared content during the video communication session.

2. The computer-implemented method of claim 1, further comprising:
detecting each user of the multiple users in the video of the multiple users; and
generating, for each user, a silhouette that defines an area in the video of the multiple users that contains the user;
wherein identifying the one of the multiple users as the presenter includes identifying a first silhouette that defines an area in the video of the multiple users that contains the presenter; and
wherein the information identifying the presenter includes information associated with the first silhouette.

3. The computer-implemented method of claim 1, wherein identifying the one of the multiple users as the presenter comprises:
presenting an image of the multiple users; and
receiving a selection of the presenter from the image.

4. The computer-implemented method of claim 1, wherein identifying the one of the multiple users comprises:
receiving audio data from one or more microphones;
identifying an active speaker based on the audio data; and
matching the active speaker to the one of the multiple users.

5. The computer-implemented method of claim 1, further comprising:
identifying a second user of the multiple users as a second presenter; and
wherein the information associated with the sharing session further comprises one of:
videos of the presenter and the second presenter overlaid on the shared content, or
the shared content, the video of the multiple users, and information identifying the presenter and the second presenter in the video of the multiple users.

6. The computer-implemented method of claim 1, wherein transmitting the information associated with the sharing session further comprises:
transmitting the shared content, the video of the multiple users, and information identifying the presenter in the video of the multiple users to the meeting server for overlaying, by the meeting server or the receiver conference endpoint, the video of the presenter and video of a second presenter participating in the video communication session via a second conference endpoint on the shared content during the video communication session.

7. The computer-implemented method of claim 1, wherein transmitting the information associated with the sharing session comprises:
transmitting the information associated with the sharing session using a content channel.

8. An apparatus comprising:
a memory;
a network interface configured to enable network communication; and
a processor, wherein the processor is configured to perform operations comprising:
receiving a selection of an option to initiate a sharing session in which a video of a user is overlaid on a presentation of shared content during a video communication session, the user being one of multiple users participating in the video communication session via a conference endpoint, the multiple users and the conference endpoint being located in a same location;
identifying one of the multiple users located in the same location as a presenter for the shared content; and
transmitting, to a meeting server, information associated with the sharing session, the information associated with the sharing session including one of:
a video of the presenter overlaid on the shared content, or
the shared content, a video of the multiple users, and information identifying the presenter in the video of the multiple users for overlaying, by the meeting server or a receiver conference endpoint, video of the presenter on the shared content during the video communication session.

9. The apparatus of claim 8, wherein the processor is further configured to perform operations comprising:
detecting each user of the multiple users in the video of the multiple users; and
generating, for each user, a silhouette that defines an area in the video of the multiple users that contains the user;
wherein the processor is further configured to perform the operation of identifying by identifying a first silhouette that defines an area in the video of the multiple users that contains the presenter; and
wherein the information identifying the presenter in the video of the multiple users includes information associated with the first silhouette.

10. The apparatus of claim 8, wherein the processor is further configured to perform the operation of identifying the one of the multiple users as the presenter by:
presenting an image of the multiple users; and
receiving a selection of the presenter from the image.

11. The apparatus of claim 9, wherein the processor is further configured to perform the operation of identifying the one of the multiple users as the presenter by:
receiving audio data from one or more microphones;
identifying an active speaker based on the audio data; and
matching the active speaker to the one of the multiple users.

12. The apparatus of claim 8, wherein the processor is further configured to perform operations comprising:
identifying a second user of the multiple users as a second presenter; and
wherein the information associated with the sharing session further comprises one of:
videos of the presenter and the second presenter overlaid on the shared content, or
the shared content, the video of the multiple users, and information identifying the presenter and the second presenter in the video of the multiple users.

13. The apparatus of claim 8, wherein the processor is configured to perform the operation of transmitting the information associated with the sharing session by:
transmitting the shared content, the video of the multiple users, and information identifying the presenter in the video of the multiple users to the meeting server for overlaying, by the meeting server of the receiver conference endpoint, the video of the presenter and video of a second presenter participating in the video communication session via a second conference endpoint on the shared content during the video communication session.

14. The apparatus of claim 12, wherein the processor is configured to perform the operation of transmitting the information associated with the sharing session by:
transmitting the information associated with the sharing session using a content channel.

15. One or more non-transitory computer readable storage media encoded with instructions that, when executed by a processor of a conference endpoint, cause the processor to execute a method comprising:
receiving a selection of an option to initiate a sharing session in which a video of a user is overlaid on a presentation of shared content during a video communication session, the user being one of multiple users participating in the video communication session via the conference endpoint, the multiple users and the conference endpoint being located in a same location;
identifying one of the multiple users located at the same location as a presenter for the shared content; and
transmitting, to a meeting server, information associated with the sharing session, wherein the information associated with the sharing session comprises one of:
a video of the presenter overlaid on the shared content, or
the shared content, a video of the multiple users, and information identifying the presenter in the video of the multiple users for overlaying, by the meeting server or a receiver conference endpoint, video of the presenter on the shared content during the video communication session.

16. The one or more non-transitory computer readable storage media of claim 15, further comprising:
detecting each user of the multiple users in the video of the multiple users; and
generating, for each user, a silhouette that defines an area in the video of the multiple users that contains each user;
wherein identifying the one of the multiple users as the presenter includes identifying a first silhouette that defines an area in the video of the multiple users that contains the presenter; and
wherein the information identifying the presenter includes information associated with the first silhouette.

17. The one or more non-transitory computer readable storage media of claim 15, wherein identifying the one of the multiple users as the presenter comprises:
presenting an image of the multiple users; and
receiving a selection of the presenter from the image.

18. The one or more non-transitory computer readable storage media of claim 15, wherein identifying the one of the multiple users comprises:
receiving audio data from one or more microphones;
identifying an active speaker based on the audio data; and
matching the active speaker to the one of the multiple users.

19. The one or more non-transitory computer readable storage media of claim 15, further comprising:
identifying a second user of the multiple users as a second presenter; and
wherein the information associated with the sharing session further comprises one of:
videos of the presenter and the second presenter overlaid on the shared content, or
the shared content, the video of the multiple users, and information identifying the presenter and the second presenter in the video of the multiple users.

20. The one or more non-transitory computer readable storage media of claim 15, wherein transmitting the information associated with the sharing session comprises:
transmitting the information associated with the sharing session using a content channel.
